(19) United States
(12) Patent Application Publication
(10) Pub. No.: US 2003/0202088 A1
(43) Pub. Date: Oct. 30, 2003

(54) Videoconference with a call center

(76) Inventor: Timothy D. Knight, Lansdale, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/308,707

(22) Filed: Dec. 2, 2002

Related U.S. Application Data
(60) Provisional application No. 60/375,307, filed on Apr. 25, 2002.

(51) Int. Cl. H04N 7/14

(52) U.S. Cl. 348/14.08

(57) ABSTRACT

A videoconference system uses an Internet Protocol (IP) based communication channel for a video portion of the videoconference and uses a Public Switched Telecommunication Network (PSTN) as an audio communication channel for an audio portion of the videoconference. The videoconference system uses a digital communication channel for a video portion of the videoconference and uses a Public Switched Telecommunication Network (PSTN) as an audio communication channel for an audio portion of the videoconference and the system integrates with an automatic call distribution system of a call center. The digital based communication channel may be used for data communication. The videoconference system may interface with a database that stores customer information.

### FIELD OF THE INVENTION

The invention relates to videoconferencing and more particularly to videoconferencing with a call center.

### BACKGROUND OF THE INVENTION

Communication with a call center, such as a customer service call center, is typically done over the telephone. For example, a person may call their bank to ask about a credit card bill. Using a telephone, however, does not provide the same experience or ‘feel’ as communicating face-to-face with another person.

Videoconferencing permits live video communication as well as audio communication between two locations. As such, videoconferencing comes closer to true face-to-face communication. Videoconferencing, however, has had limited success due to negative factors, such as unavailability of a common network interface, overly complex controls, poor video quality, limited functionality, inconvenience, high cost, and the like.

Most current videoconferencing systems are implemented via an Integrated Services Digital Network (ISDN). Such ISDN based videoconferencing systems typically provide reasonable audio and video communication. One disadvantage with ISDN videoconferencing, however, is that each party to the teleconference is required to have access to an ISDN connection. These ISDN connections may be too expensive for some people. While many large companies have access to ISDN connections, there are still a large number of people who do not have ISDN connections for a variety of reasons. One category of such people is physicians. Many physicians are solo practitioners or are part of a small medical practice. As such, these physicians often do not have access to ISDN connections.

However, many physicians have Internet Protocol (IP) connections (e.g., to access Internet web pages, etc.) and videoconferencing can take place over an IP connection. Current IP videoconferencing has some disadvantages, the most significant of which is that received video and audio can be “choppy” and hard to understand. Further, with IP videoconferencing, both the audio and video communication is carried over the same communication channel. As such, a problem with that communication channel can result in the loss of both audio and video communication.

Moreover, an IP videoconference typically does not interface with other systems, such as for example, call center systems. Call center systems have developed over the years into relatively sophisticated systems. For example, call center systems can perform automatic call distribution and can interface with databases containing customer information. Although such systems can provide increased levels of customer support, there is currently no method for integrating a videoconference with a call center system. Therefore, existing videoconferences do not leverage the infrastructure of existing call center systems.

Therefore, there is a need for a user-friendly videoconferencing system and method with improved communications that can interface with a call center system.

### SUMMARY OF THE INVENTION

The invention relates to a method of establishing a videoconference between a customer system having a corresponding customer computer and a corresponding customer telephone and a call center system having a corresponding call center telephone and a corresponding call center computer. A request is received from the customer computer for a videoconference. An identification of a customer telephone and an identification of the customer computer is also received. An identification of the call center computer is determined. A video communication channel is established between the customer computer and the call center computer based on the identification of the customer computer and the identification of the call center computer. An audio communication channel is established between the customer telephone and the call center telephone based on the identification of the customer telephone. The videoconference proceeds with an audio portion thereof communicated through the audio communication channel and the video portion thereof communicated through the video communication channel.

The invention also relates to a method of providing a videoconference between a customer system having a corresponding customer computer and a corresponding customer telephone, and a call center system having a corresponding call center telephone and a corresponding call center computer. A video Internet Protocol communication channel is provided between the customer computer and the call center computer. An audio communication channel is provided between the customer telephone and the call center telephone via a public switched telephone network. The videoconference proceeds with an audio portion thereof communicated through the audio communication channel and the video portion thereof communicated through the video Internet Protocol communication channel.

Further, the invention relates to a method of providing a videoconference between a customer system having a corresponding customer computer and a call center system having a corresponding call center computer. The call center computer selects from a plurality of call center computers via automatic call distribution. A video and audio Internet Protocol communication channel is provided between the customer computer and the call center computer. The videoconference proceeds with an audio and video portion thereof communicated through the audio and video Internet Protocol communication channel.

The invention also relates to an integration system for providing a videoconference between a customer system having a corresponding customer computer and a corresponding customer telephone and a call center system having a corresponding call center telephone and a corresponding call center computer. The integration system comprises a videoconference and call management server and an integration server. The videoconference and call management server is in communication with the customer computer and the call center system. The integration server is in communication with the customer computer and the videoconference and call management server. The integration server receives a request for a videoconference and the integration server and the videoconference and call management server cause establishment of an audio communication channel between the customer telephone and the call center telephone and cause establishment of a video communication channel between the customer computer and the call center computer.

The invention further relates to a system for videoconferencing between a customer system having a corresponding customer computer and a corresponding customer telephone and a call center system having a corresponding call center telephone and a corresponding call center computer. The system comprises an integration system and a call center system. The integration system comprises a videoconference and call management server and an integration server. The videoconference and call management server is in communication with the customer computer. The integration server is in communication with the customer computer and the videoconference and call management server. The call center system comprises a phone switch and a computer telephony server. The phone switch has automatic call distribution and is in communication with the call center telephone. The computer telephony server is in communication with the phone switch, the call center computer, and the integration system.

The above-listed features, as well as other features of the invention are more fully set forth hereinafter.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a schematic diagram in elevation of an illustrative system for Internet Protocol based videoconferencing with a call center, in accordance with an embodiment of the invention; and

FIGS. 2a-2d are schematic flow diagrams in elevation of an illustrative method for Internet Protocol based videoconferencing with a call center, in accordance with an embodiment of the invention.

### DETAILED DESCRIPTION OF ILLUSTRATIVE EMBODIMENTS

The invention is directed to a videoconference system and method that uses a video communication channel for the video portion of the videoconference and an audio communication channel for the audio portion of the videoconference. The video portion of the videoconference may be implemented via the Internet and the audio portion of the videoconference may be implemented via a Public Switched Telecommunication Network (PSTN). Alternatively, both the video and audio portion may be implemented via an Internet Protocol communication channel and the videoconference system may interface with an automatic call distribution system of a call center.

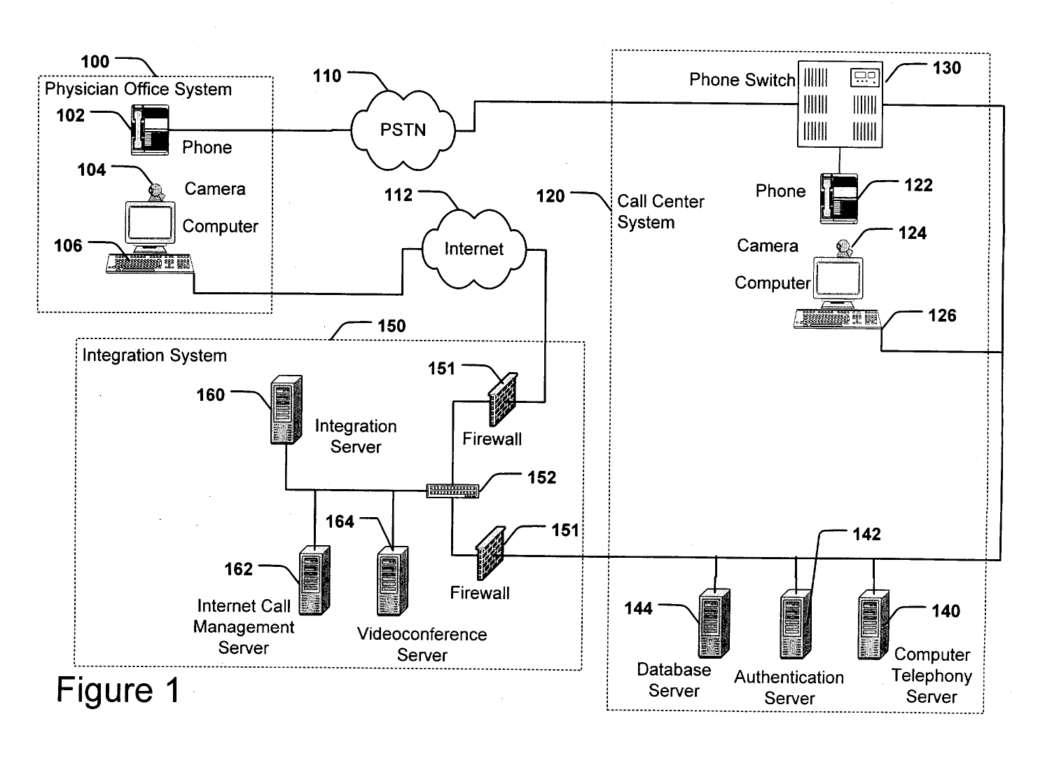

FIG. 1 is a high level diagram of an illustrative system for IP based videoconferencing between a physician office system 100 and a call center system 120. As shown in FIG. 1, physician office system 100 includes a telephone 102 and a computer 106 with a camera 104. While the following description of illustrative embodiments includes a physician office 100, the invention may be applied to any person such as a customer and the like.

Physician telephone 102 is in communication with public switched telephone network (PSTN) 110 thereby providing an audio communication channel to the physician office. Alternatively, the audio communication channel may be provided by another communication system, such as, for example, a wireless telephone system, a voice over IP system, and the like.

Physician computer 106 is in communication with a digital communication network such as the Internet 112, thereby providing a digital video and data communication channel to physicians office system 100. Typically, physician computer 106 communicates with the Internet 112 over a broadband communication link to provide high speed video and data communication. Typically, the communication link is a Digital Subscriber Line (DSL) connection; although any other appropriate link may be employed. Physician computer 106 may communicate with the Internet 112 via an Internet Service Provider. Camera 104 of physician computer 106 provides video images, typically video images of the physician. Physician computer 106 also includes a browser for the physician to interface with remote data servers, call center system 120, and elsewhere, via the Internet 112.

Call center system 120 includes a telephone 122, a computer 126, a phone switch 130, a database server 144, and a computer telephony server 140. Call center system 120 may include other servers, such as, for example, an authentication server 142, and the like. Phone switch 130, computer 126, database server 144, computer telephony server 140, authentication server 142, and other like elements are in communication with each other, typically through a local area network (LAN).

Call center telephone 122 is in communication with PSTN 110 via phone switch 130, thereby providing an audio communication channel to call center system 120. Call center telephone 122 is typically a digital telephone to interface with computer telephony server 140.

Phone switch 130 provides communication between call center telephone 122 and PSTN 110. Phone switch 130 includes Automatic Call Distribution (ACD) functionality. Such ACD functionality can help a call center to increase call center representative productivity and effectively utilize resources. For example, ACD may attempt to distribute incoming calls evenly, so representative productivity is maintained at a high level and inbound telephone calls are handled efficiently. ACD may attempt to evenly distribute incoming telephone calls by maintaining statistics on the call center representatives and when an incoming call is received, ACD may select the representative that has been off the phone for the longest.

ACD may also map (or “split”) physicians to a subset of the call center representatives, may map consumers to another subset of call center representatives, and may map sales representatives to yet another subset of call center representatives. Physicians may also be mapped to particular call center representatives that are well educated in that physician's field of practice. Another split may be configured in the ACD to map physicians requesting a videoconference to another subset of call center representatives. In this manner, call center representatives may establish working relationships with the physician by continually dealing with the same physician.

The ACD may also provide management tools and operational overviews that monitor traffic, measure representative productivity, isolate problem areas, reallocate resources as the situation demands, compile historic reports, and the like. Such a phone switch with ACD is commercially available from Avaya Incorporated of Basking Ridge, N.J.

Call center computer 126 is in communication with the Internet 112 thereby providing a video and data communication channel to call center system 120. Typically, call center computer 126 communicates with the Internet 112 via a LAN to provide high speed video and data communication. Call center computer 126 may communicate with the Internet 112 via a Ti line and the like. Call center computer 126 further includes a camera 124 that provides video images, typically video images of a call center representative. Camera 124 may be a high quality camera to provide the physician with a high quality video image of the call center representative.

Computer telephony server 140 integrates call center telephone 122 and call center computer 126. The integration may be accomplished by associating a call center representative identification (e.g., that may be entered or assigned upon login to the phone switch) with an identification of the call center computer (e.g., that may be entered or assigned upon login to the LAN, such as a domain name). With such an association, applications may send information to the telephone and/or the computer of a particular call center representative. A computer telephony server is commercially available from the aforementioned Avaya Incorporated, for example, version 9.5.08.0.

In alternative embodiments in which the call center uses the computer for both audio and video communication, phone switch 130 and computer telephony server 140 may be replaced with a server that includes ACD functionality for mapping between call center representatives and their corresponding computers.

Database server 144 stores and retrieves information. Typically, the information is related to the physician, such as, for example, a physician identification number, an address, affiliations with clinics, demographic information, and the like. Database server 144 may also include a database of responses to physician questions about a product. Moreover, database server 144 may include the dates on which the physician spoke with the call center, the products discussed, the patient symptoms, and the like. Database server 144 may further include prescribing data, quality control information, adverse patient experience reports, sample ordering data that can be linked to a sample ordering system, consumer data, and the like. In this manner, the call center representative may view more detailed information about the physician prior to and while talking to the physician.

Authentication server 142 provides authentication for user login and the like and may be any authentication server.

Call center system 120 may access integration system 150 to integrate a video communication channel and an audio communication channel and to further integrate the video and audio communication channel with call center system 120. Integration system 150, as shown, comprises an integration server 160, an Internet call management server 162, a videoconference server 164, and a load balancer 152. The devices of integration system 150 may be located in a physically separate location or may be located proximate call center system 120. The devices of integration system 150 may communicate with call center system 120 via a LAN, a wide area network (WAN), and the like. In any event, the devices of integration system 150 are typically located behind firewalls 151 to provide some device protection.

Videoconference server 164 sets up an IP videoconference between two or more computers, such as physician computer 106 and call center computer 126. An exemplary videoconference server 164 is commercially available from First Virtual Communications Company of Santa Clara, Calif.

Internet call management server 162 receives a request from a physician (via the Internet 112) for a telephone call from a call center representative and coordinates such a telephone call through phone switch 130. For example, Internet call management server 162 may receive a request including a physician telephone number and a physician name. Internet call management server 162 may send such information to phone switch 130 to be processed by ACD. A server that can function as an Internet call management server is commercially available from the aforementioned Avaya Incorporated, for example, version 4.5.7.5.

Integration server 160 is a web server that receives a request from a physician for a videoconference and coordinates the request with other devices to provide a videoconference between the physician at physician office system 100 and the call center representative at call center system 120. In addition, integration server 160 may include web pages that describe medical products, medical information, and the like. Such information may be useful to a physician in prescribing medication; however, the amount of information in such web pages can become very large and unmanageable to a physician who has limited time to search through pages and pages of medical information. To overcome such a disadvantage, videoconference server 164 or integration server 160 may be configured to interface with call center computer 126 such that the call center representative can select the web pages to be displayed on the browser of physician computer 106, as described in more detail below.

Integration system 150 integrates an audio communication channel (i.e., between physician phone 102 and call center representative phone 122) with a video communication channel (i.e., between physician computer 106 and call center representative computer 126). With such an integration of audio and video, integration system 150 may establish an IP video communication channel and a telephonic audio communication channel, thereby combining the high-reliability of a telephonic audio communication channel with IP video communications. In this manner, even if the IP video communication channel malfunctions, a physician may still verbally communicate with a call center representative.

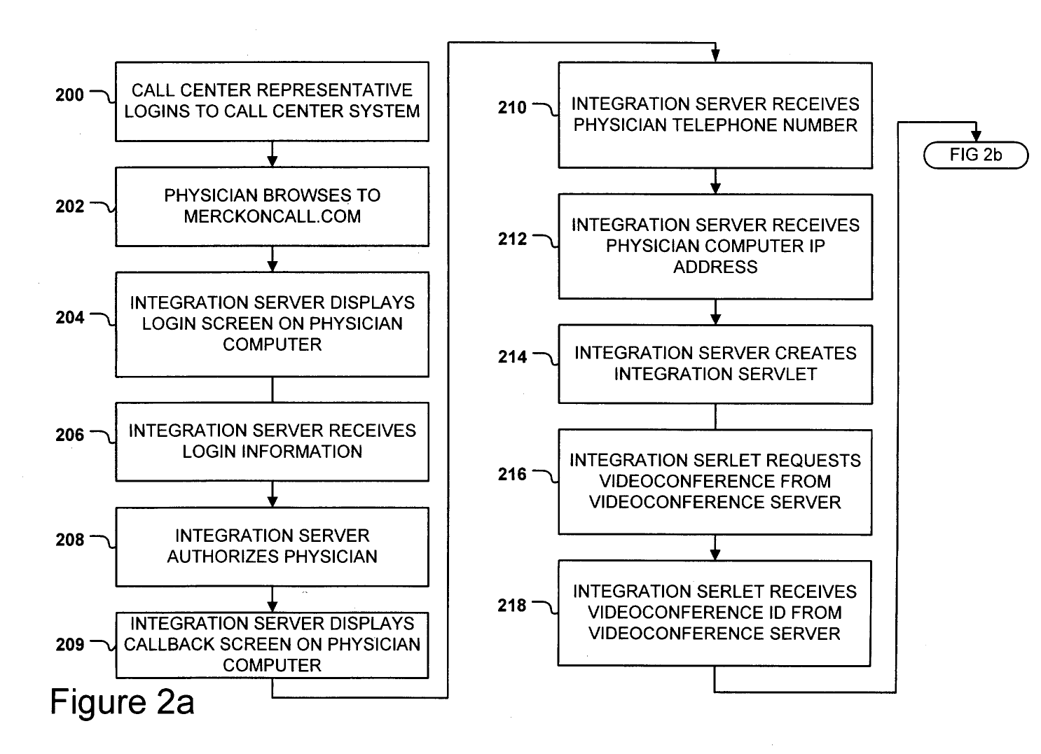

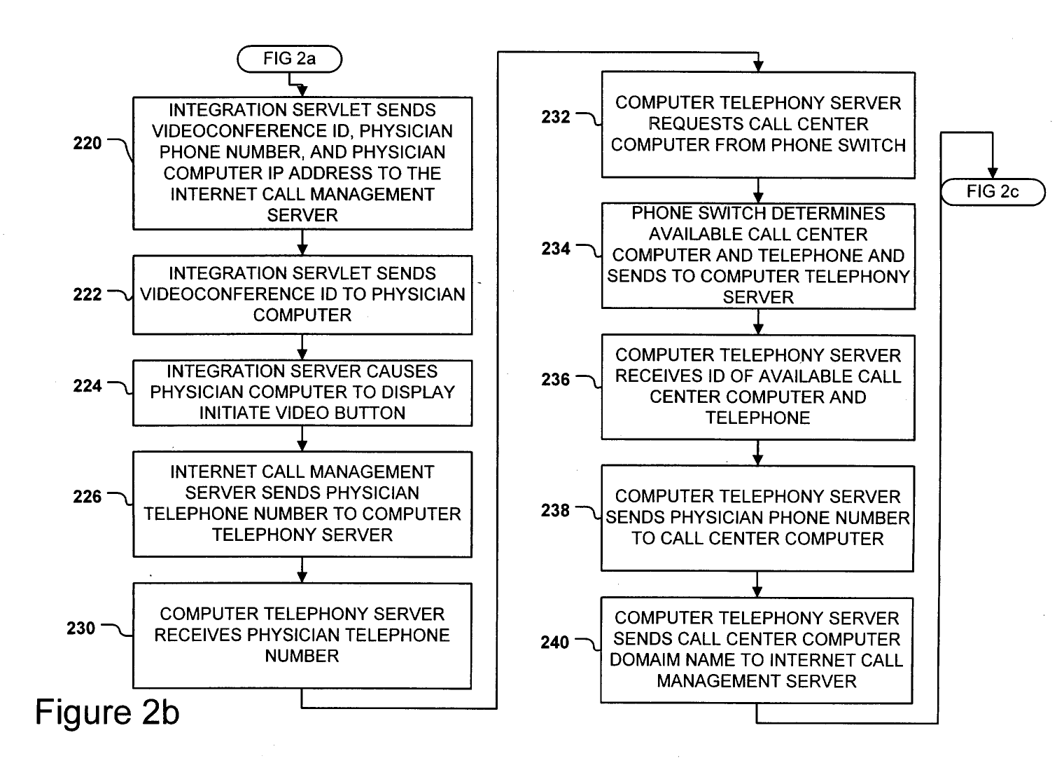

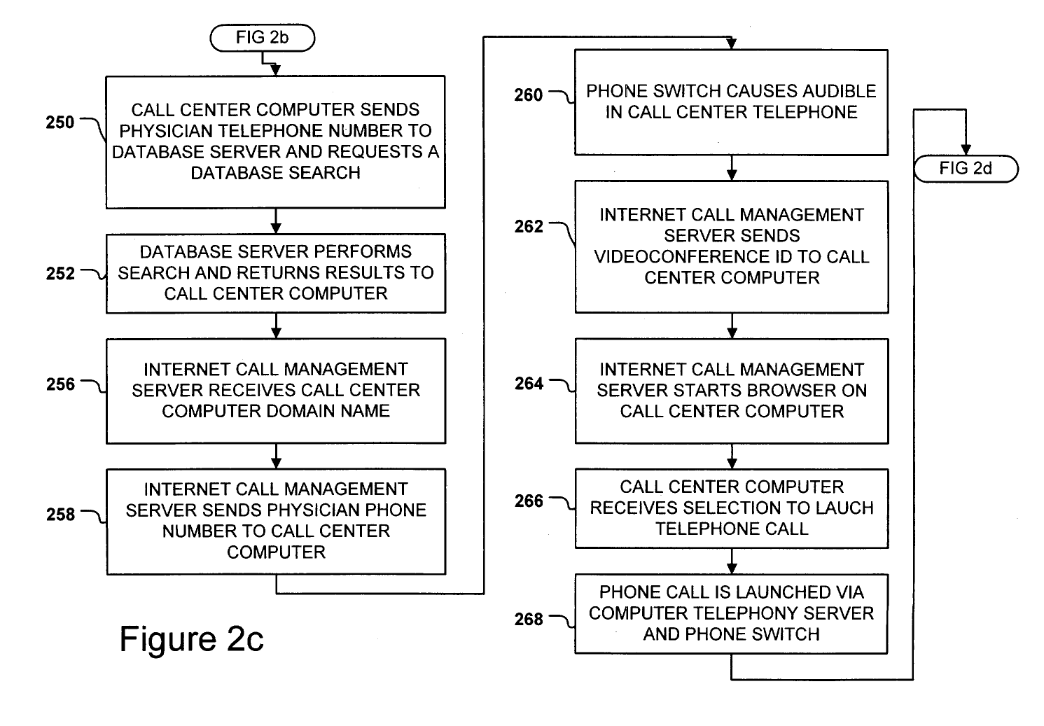

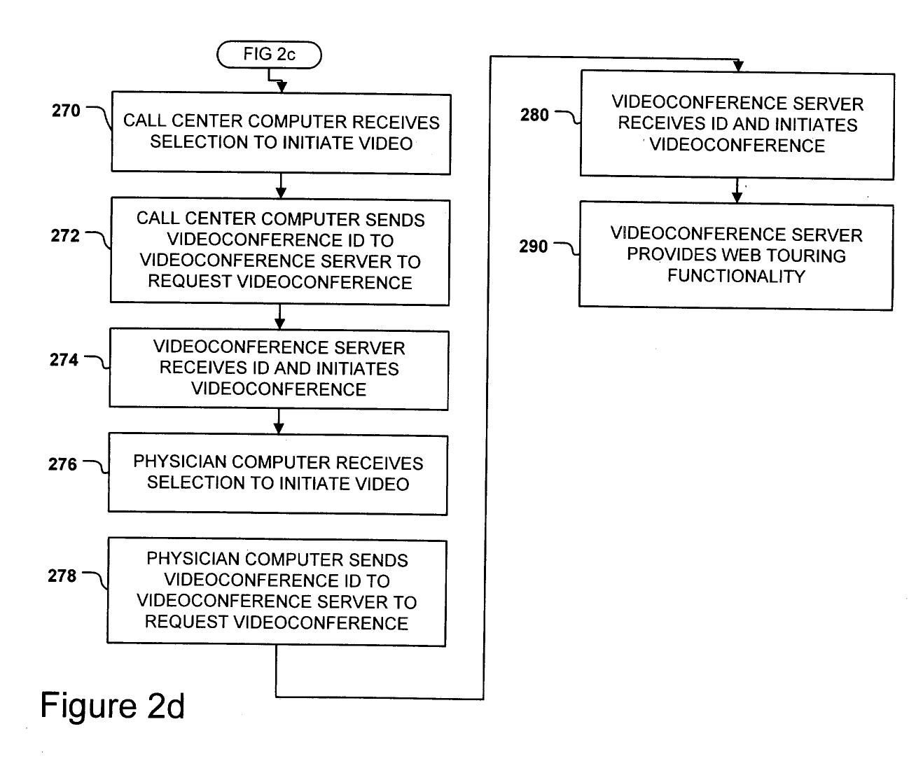

Integration system 150 also interfaces with call center system 120 thereby possibly leveraging the infrastructure of an existing call center to include the functionality of call center system 120. With such an integration to a call center system, the videoconference may include enhanced features, such as, for example, access to a physician's historical data, mapping of telephone calls to particular call center representatives, and the like, as described in more detail in connection with FIGS. 2a through 2d.

FIGS. 2a through 2d show an illustrative method for videoconferencing between physician office system 100 and call center system 120. Before integration server 160 receives any request from the physician, the call center representative typically logs into various applications, as shown at step 200. For example, the call center representative may login to computer telephony server 140. Upon logging into computer telephony server 140, computer telephony server 140 may request and receive an identification of the call center representative and an identification of call center computer 126 (e.g., a domain name). The call center representative also may login to phone switch 130 and be mapped via ACD to receive requests from integration server 160 (e.g., be mapped to the split that handles videoconference requests). The call center representative may further log into database server 144.

At this point, the call center representative is appropriately logged in to call center equipment and available to begin videoconferencing. Now returning to the physician, at step 202, the physician enters a Universal Resource Locator (URL) into a browser on physician computer 106. For example, the physician may enter “http:/www.merckoncall.com” into the browser.

In more detail, to communicate with integration server 160, the physician at the physician computer 106 executes a browser and then enters an address, such as a domain name (for example, “http:/www.merckoncall.com”) or a URL (for example, “http:/www.merckoncall.com/login.htm”). If the URL “http:/www.merckoncall.com/login.htm” is entered, the browser breaks the URL into 3 parts: the protocol (“http”), the server name (“www.merckoncall.com”), and the file name (“login.htm”). In either case, the browser communicates with a domain name server (not shown) to translate the server name (www.merckoncall.com) into an IP address. The browser then uses the IP address to connect physician computer 106 to integration server 160 via a communications network, e.g., the Internet 112.

Next, at step 204, integration server 160 sends information to physician computer 106 that causes the browser to display a login screen. The physician may enter a valid username and password into the appropriate fields in the login screen and selects to send the login information to integration server 160. Upon receiving the selection, physician computer 106 sends the login information to integration server 160.

At step 206, integration server 160 receives the login information. At step 208, integration server 160 authenticates the login information. Typically, integration server 160 sends the login information to authentication server 142. Authentication server 142 compares the login information against data in a data store containing login information of authorized users and returns an authorization status to integration server 160. Alternatively, integration server 160 may include a data store containing login information of authorized users and may perform the authentication against its own data store.

If the determined authorization status is that the physician is authorized, integration server 160 sends information to physician computer 106 that causes the browser to display a screen indicating that the physician is authorized to request a videoconference and requesting telephone callback information, as shown at step 209. The browser may display a prompt for the physician to select to contact a call center representative and fields for the physician to enter physician telephone callback information such as, for example, a telephone number for the physician, a telephone extension, a physician name, a zip code, and the like. The physician enters the appropriate information in the fields and selects to send the physician telephone callback information to integration server 160.

Upon receiving the selection, physician computer 106 sends the physician telephone callback information to integration server 160. At step 210, integration server 160 receives the physician telephone callback information from physician computer 106.

Physician computer 106 may also send physician computer information to integration server 160, such as, for example, the IP address of physician computer 160, the browser version, and the like. The physician computer information may be determined by the physician browser and therefore, the physician need not enter such information into physician computer 106. At step 212, integration server 160 receives the physician computer information from physician computer 106.

As shown at step 214, upon receiving the physician telephone callback information and the physician computer information, integration server 160 may create an integration servlet that parses the received physician telephone callback information and physician computer information and creates a temporary java object based on the parsed information.

At step 216, the integration servlet then requests videoconference information to initiate a videoconference (e.g., a videoconference identification, a videoconference server name, and the like) from a servlet on videoconference server 164.

At step 218, the integration servlet receives the videoconference information from videoconference server 164.

At step 220, the integration servlet sends the videoconference information, the physician telephone callback information, and the physician computer information to Internet call management server 162.

At step 222, the integration servlet also sends the videoconference information to physician computer 106.

At step 224, integration server 160 causes physician computer 106 browser to display a screen including a “Start Video” button which may be used to start the videoconference at a subsequent time.

At step 226, Internet call management server 162 sends the physician telephone callback information to computer telephony server 140.

At step 230, computer telephony server 140 receives the physician telephone callback information At step 232, computer telephony server 140 requests an available representative from phone switch 130 using ACD functionality. Typically, computer telephony server 140 sends the physician telephone callback information to phone switch 130.

At step 234, phone switch 130 selects from the “split” of representatives that are mapped to videoconferences based on the physician telephone callback information and sends an identification of the selected call center telephone to computer telephony server 140.

At step 236, computer telephony server 140 receives an identification of an available call center representative (corresponding to available call center telephone 122) from phone switch 130, and determines the identification of the available call center computer 126 based on the identification of the available call center telephone 122.

At step 238, computer telephony server 140 sends the physician telephone callback information to a telephony client (e.g., FASTCALL® application version 3.0.0.17 commercially available from the aforementioned Avaya) on the selected call center computer 126.

At step 240, computer telephony server 140 sends the call center computer identification (e.g., the call center computer domain name) to Internet call management server 162.

At step 250, when the telephony client on call center computer 126 receives the physician telephone callback information, the telephony client may automatically send such information to a call center database client application (e.g., a SIEBEL® application, a PEOPLESOFT® application, and the like) on call center computer 126.

The telephony client may then automatically request the call center database server 144 to use the physician telephone callback information to launch a search in the call center database.

At step 252, the call center database application may perform the requested search based on a search criteria (e.g., the physician telephone number, the physician name, and the like) and return a list of matching physician names to the call center database client application on the call center computer 126. The call center representative then selects the appropriate physician from the list shown in the call center database application. The call center database application then requests the remaining call center data (e.g., physician historical data, demographics, prescribing information, previous call notes, and the like) from call center database server 144. Call center database server 144 returns the call center data for the selected physician to the call center application on the call center computer 126. At this point, the call center representative has access to physician database information. As such, the call center representative reviews this information and determine a course of discussion to follow with the physician during the videoconference.

At step 256, Internet call management server 162 receive the call center computer information that was sent at step 240.

At step 258, Internet call management server 162 sends the physician telephone callback information (e.g., the physician telephone number) via an applet to call center computer 126.

At step 260, phone switch 130 causes an audible signal to be broadcast at the selected call center telephone to alert the call center representative of the callback request.

At step 262, Internet call management server 162 sends the videoconference information to call center computer 126.

At step 264, Internet call management server 162 causes a browser window to open on call center computer 126 which may also display a “Start Video” button that is used to subsequently launch a videoconference using the videoconference information (i.e., which passed to Internet call management server 162 from integration server 160).

The call center representative, using computer 126, selects to launch a phone call to the physician. The call center computer 126 (e.g., an applet on the call center computer) receives the selection, at step 266.

At step 268, computer telephony server 140 uses the physician telephone callback information received from the integration server 160 (as entered by the physician on into the physician computer browser) to cause phone switch 130 to launch a telephone call to physician telephone 102.

Once the physician has answered the phone call and the audio communication channel is established, the call center representative may advise the physician to select the “Start Video” button displayed on physician computer 106. The physician selects the “Start Video” button displayed in the browser on physician computer 106 and the call center representative selects the “Start Video” button displayed in the browser on call center computer 126.

At step 270, the browser on call center computer 126 receives the selection to initiate a videoconference. At step 272, call center computer 126 sends the videoconference information to videoconference server 164 to request a videoconference session.

At step 274, videoconference server 164 receives and verifies the videoconference information and allows the call center representative browser to initiate a videoconference session to videoconference server 164.

At step 276, the browser on physician computer 106 receives the selection to initiate a videoconference. At step 278, physician computer 106 sends the videoconference information to videoconference server 164 to request a videoconference session.

At step 280, videoconference server 164 receives and verifies the videoconference information and initiates a videoconference session between physician computer 106 and call center computer 126 through videoconference server 164.

At step 290, videoconference server 164 also provides web-touring functionality. The web-touring allows the call center representative to browse to a specified URL in a frame in the call center representative's browser and then push that URL to physician computer 106 within a frame in the same browser as the videoconference. Such web-touring functionality may be provided by videoconferencing server 164 (e.g., a videoconference server commercially available from the aforementioned First Virtual Communications Company). Such functionality may be implemented with a software development kit provided with a videoconference server commercially available from First Virtual Communications Company. As such, a data communication channel is established between physician computer 106 and call center computer 126. While the data communication channel is described as communicating web pages from the call center computer 126 to the physician computer 106, the data communication may be used to communicate other data.

In the foregoing description, it can be seen that the invention provides a videoconference that may use a PSTN connection for audio communication and an IP connection for video and data communication. Further, the videoconference may integrate with automatic call distribution of a call center system to leverage the existing technology installed in such a call center system. As such, a user-friendly videoconferencing system and method is provided that uses IP, yet does not suffer as much from “choppy” video or audio and can interface with a call center system.

Portions of the invention may be embodied in the form of program code (i.e., instructions) stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer, the machine becomes an apparatus for practicing the invention. Portions of the invention may also be embodied in the form of program code that is transmitted over some transmission medium, such as over electrical wiring or cabling, through fiber optics, over a network, including the Internet or an intranet, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

It is to be understood that the foregoing illustrative embodiments have been provided merely for the purpose of explanation and are in no way to be construed as limiting of the invention. Words which have been used herein are words of description and illustration, rather than words of limitation. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

1. A method for establishing a videoconference between a customer system having a corresponding customer computer and a corresponding customer telephone, and a call center system having a corresponding call center telephone and a corresponding call center computer, comprising:
receiving, from the customer computer, a request for a videoconference, an identification of a customer telephone, and an identification of the customer computer;
determining an identification of the call center computer;
establishing a video communication channel between the customer computer and the call center computer based on the identification of the customer computer and the identification of the call center computer; and
causing establishment of an audio communication channel between the customer telephone and the call center telephone based on the identification of the customer telephone,
wherein the videoconference is provided with the video portion thereof communicated through the video communication channel and with the audio portion thereof communicated through the audio communication channel.

2. The method as recited in claim 1, wherein the video communication channel comprises an Internet Protocol communication channel.

3. The method as recited in claim 2, wherein receiving the request for the videoconference comprises receiving, from the customer computer, an Internet Protocol address of the customer computer.

4. The method as recited in claim 1, wherein receiving the request for the videoconference further comprises receiving, from a browser of the customer computer, a customer telephone number corresponding to the customer telephone.

5. The method as recited in claim 1, wherein determining the identification of the call center computer comprises receiving, from the call center system, a domain name of the call center computer.

6. The method as recited in claim 1, wherein the call center system comprises a computer telephony server.

7. The method as recited in claim 1, wherein determining the identification of the call center computer comprises sending the identification of the customer telephone to the computer telephony server.

8. The method as recited in claim 7, wherein determining the identification of the call center computer further comprises receiving the identification of the call center computer from the computer telephony server in response to sending the identification of the customer telephone to the computer telephony server.

9. The method as recited in claim 1, wherein the audio communication channel comprises an audio communication channel via a public switched telephone network.

10. The method as recited in claim 1, wherein establishing the video communication channel comprises:
receiving a request for a video communication channel from the customer computer;
receiving a request for a video communication channel from the call center computer;
determining a videoconference information corresponding to the video communication channel between the customer computer and the call center computer;
sending the videoconference information to the customer computer; and
sending the videoconference information to the call center computer.

11. The method as recited in claim 10, wherein the videoconference information is selected from one of a videoconference identification, a videoconference server name, and combinations thereof.

12. The method as recited in claim 1, wherein the call center system comprises a computer telephony server.

13. The method as recited in claim 12, wherein causing establishment of the audio communication channel comprises sending the identification of the customer telephone to the computer telephony server.

14. The method as recited in claim 1, wherein causing establishment of the audio communication channel comprises selecting the call center telephone from a set of call center telephones based on the identification of the customer telephone.

15. The method as recited in claim 14, wherein selecting the call center telephone comprises selecting, via automatic call distribution functionality of a phone switch, the call center telephone from a set of call center telephones based on the identification of the customer telephone, mapping between customer telephone identifications and call center telephones of the set of call center telephones, and determining the availability of call center telephones from the set of call center telephones.

16. The method as recited in claim 1, further comprising determining historical telephone call information based on the identification of the customer telephone and displaying the historical telephone call information on the call center computer.

17. The method as recited in claim 1, further comprising:
establishing a data communication channel between the customer computer and the call center computer based on the identification of the customer computer and the identification of the call center computer.

18. The method as recited in claim 17, further comprising:
pushing a web page from a browser of the call center computer to a browser of the customer computer via the data communication channel.

19. A method for providing a videoconference between a customer system having a corresponding customer computer and a corresponding customer telephone, and a call center system having a corresponding call center telephone and a corresponding call center computer, comprising:
providing a video Internet Protocol communication channel between the customer computer and the call center computer; and
providing an audio communication channel between the customer telephone and the call center telephone via a public switched telephone network, the videoconference proceeding with an audio portion thereof communicated through the audio communication channel and the video portion thereof communicated through the video Internet Protocol communication channel.

20. The method as recited in claim 19, wherein providing the video Internet Protocol communication channel comprises:
receiving, from the customer computer, an identification of the customer computer;
sending the identification of the customer telephone to the call center system;
receiving an identification of the call center computer in response to sending the identification of the customer telephone to the call center; and
establishing a video Internet Protocol communication channel between the customer computer and the call center computer based on the identification of the customer computer and the identification of the call center computer.

21. The method as recited in claim 19, wherein providing the audio communication comprises:
sending the identification of the customer telephone to the call center system.

22. The method as recited in claim 19, further comprising:
establishing a data communication channel between the customer computer and the call center computer based on the identification of the customer computer and the identification of the call center computer.

23. The method as recited in claim 22, further comprising:
pushing a web page from a browser of the call center computer to a browser of the customer computer via the data communication channel.

24. A method for providing a videoconference between a customer system having a corresponding customer computer and a call center system having a corresponding call center computer, comprising:
selecting a call center computer from a plurality of call center computers via automatic call distribution; and
providing a video and audio Internet Protocol communication channel between the customer computer and the call center computer, the videoconference proceeding with an audio and video portion thereof communicated through the audio and video Internet Protocol communication channel.

25. The method as recited in claim 24, wherein providing the video and audio Internet Protocol communication channel comprises:
receiving, from the customer computer, an identification of the customer computer;
sending the identification of the customer computer to the call center system;
receiving an identification of the call center computer in response to sending the identification of the customer computer to the call center system; and
establishing a video and audio Internet Protocol communication channel between the customer computer and the call center computer based on the identification of the customer computer and the identification of the call center computer.

26. The method as recited in claim 24, further comprising:
receiving an identification of the customer computer; and
determining customer historical information based on the identification of the customer computer.

27. The method as recited in claim 24, further comprising:
establishing a data communication channel between the customer computer and the call center computer based on the identification of the customer computer and the identification of the call center computer.

28. The method as recited in claim 27, further comprising:
pushing a web page from a browser of the call center computer to a browser of the customer computer via the data communication channel.

29. An integration system for videoconferencing between a customer system having a corresponding customer computer and a corresponding customer telephone, and a call center system having a corresponding call center telephone and a corresponding call center computer, comprising:
a videoconference and call management server in communication with the customer computer and the call center system; and
an integration server in communication with the customer computer and the videoconference and call management server;
wherein upon the integration server receiving a request for a videoconference, the integration server, the videoconference and call management server cause establishment of an audio communication channel between the customer telephone and the call center telephone, and cause establishment of a video communication channel between the customer computer and the call center computer.

30. The integration system as recited in claim 29, wherein the integration server receives, from the customer computer, a request for a videoconference, an identification of a customer telephone, and an identification of the customer computer, the integration server sends the identification of the customer telephone to the call center system for establishment of an audio communication channel between the call center telephone and the customer telephone, wherein the integration server sends the identification of the customer computer to the videoconference and call management server, and wherein the videoconference and call management server receives the identification of the customer computer and the identification of the call center computer and establishes a video communication channel between the customer computer and the call center computer based on the identification of the customer computer and the identification of the call center computer.

31. The integration system as recited in claim 29, further comprising:
a firewall interposed between the integration system and the customer system; and
a firewall interposed between the integration system and the call center system.

32. The integration system as recited in claim 29, wherein the videoconference and call management server establishes a video Internet Protocol communication channel.

33. A system for videoconferencing between a customer system having a corresponding customer computer and a corresponding customer telephone, and a call center system having a corresponding call center telephone and a corresponding call center computer, comprising:
an integration system, comprising:
a videoconference and call management server in communication with the customer computer; and
an integration server in communication with the customer computer and the videoconference- and call management server, and
a call center system, comprising:
a phone switch having automatic call distribution, the phone switch in communication with the call center telephone; and
a computer telephony server in communication with the phone switch, the call center computer, and the integration system.

34. The system as recited in claim 33, further comprising:
a firewall disposed between the integration system and the customer system; and
a firewall disposed between the integration system and the call center system.

35. The system as recited in claim 33, wherein the integration server receives, from the customer computer, a request for a videoconference, an identification of a customer telephone, and an identification of the customer computer, the integration server sends the identification of the customer telephone to the call center system for establishment of an audio communication channel between the call center telephone and the customer telephone, the integration server sends the identification of the customer computer to the videoconference and call management server, and the videoconference and call management server receives the identification of the customer computer and the identification of the call center computer and establishes a video communication channel between the customer computer and the call center computer based on the identification of the customer computer and the identification of the call center computer.

36. The system as recited in claim 35, wherein the videoconference and call management server establishes a video Internet Protocol communication channel.

37. The system as recited in claim 33, wherein the call center system further comprises:
a database server in communication with the call center computer, the database server containing historical telephone call information.

38. The system as recited in claim 33, wherein the call center system further comprises:
an authorization server in communication with the integration system, the authorization server containing user authorization information.

39. A computer-readable medium having computer-executable instructions thereon for establishing a videoconference between a customer system having a corresponding customer computer and a corresponding customer telephone, and a call center system having a corresponding call center telephone and a corresponding call center computer, the computer-executable instructions when executed on a processor causing the processor to perform the following:
receiving, from the customer computer, a request for a videoconference, an identification of a customer telephone, and an identification of the customer computer;
determining an identification of the call center computer;
establishing a video communication channel between the customer computer and the call center computer based on the identification of the customer computer and the identification of the call center computer; and
causing establishment of an audio communication channel between the customer telephone and the call center telephone based on the identification of the customer telephone, the videoconference proceeding with an audio portion thereof communicated through the audio communication channel and the video portion thereof communicated through the video communication channel.

40. The computer-readable medium as recited in claim 39, wherein the call center system comprises a computer telephony server, and wherein determining the identification of the call center computer comprises sending the identification of the customer telephone to the computer telephony server.

41. The computer-readable medium as recited in claim 39, wherein establishing the video communication channel comprises:
receiving a request for a video communication channel from the customer computer;
receiving a request for a video communication channel from the call center computer;
determining a videoconference information corresponding to the video communication channel between the customer computer and the call center computer;
sending the videoconference information to the customer computer; and
sending the videoconference information to the call center computer.

42. The computer-readable medium as recited in claim 39, wherein the call center system comprises a computer telephony server and causing establishment of the audio communication channel comprises sending the identification of the customer telephone to the computer telephony server and wherein selecting the call center telephone comprises selecting, via automatic call distribution functionality of a phone switch, the call center telephone from a set of call center telephones based on the identification of the customer telephone, a mapping between customer telephone identifications and call center telephones of the set of call center telephones, and the availability of call center telephones of the set of call center telephones.

43. A computer-readable medium having computer-executable instructions thereon for providing a videoconference between a customer system having a corresponding customer computer and a corresponding customer telephone and a call center system having a corresponding call center telephone and a corresponding call center computer, the computer-executable when executed on a processor causing the processor to perform the following:
providing a video Internet Protocol communication channel between the customer computer and the call center computer; and
providing an audio communication channel between the customer telephone and the call center telephone via a public switched telephone network, the videoconference proceeding with an audio portion thereof communicated through the audio communication channel and the video portion thereof communicated through the video Internet Protocol communication channel.

44. The computer-readable medium as recited in claim 43, wherein providing the video Internet Protocol communication channel comprises:
receiving, from the customer computer, an identification of the customer computer;
sending the identification of the customer telephone to the call center system;
receiving an identification of the call center computer in response to sending the identification of the customer telephone to the call center; and
establishing a video Internet Protocol communication channel between the customer computer and the call center computer based on the identification of the customer computer and the identification of the call center computer.

45. The computer-readable medium as recited in claim 43, wherein the instructions further cause the processor to perform the following:
establishing a data communication channel between the customer computer and the call center computer based on the identification of the customer computer and the identification of the call center computer.

46. The computer-readable medium as recited in claim 45, wherein the instructions further cause the processor to perform the following:
pushing a web page from a browser of the call center computer to a browser of the customer computer via the data communication channel.

47. A computer-readable medium having computer-executable instructions thereon for providing a videoconference between a customer system having a corresponding customer computer and a call center system having a corresponding call center computer, the computer-executable when executed on a processor causing the processor to perform the following:
selecting the call center computer from a plurality of call center computers via automatic call distribution; and
providing a video and audio Internet Protocol communication channel between the customer computer and the call center computer, the videoconference proceeding with an audio and video portion thereof communicated through the audio and video Internet Protocol communication channel.

48. The computer-readable medium as recited in claim 47, wherein providing a video and audio Internet Protocol communication channel comprises:
receiving, from the customer computer, an identification of the customer computer;
sending the identification of the customer computer to the call center system;
receiving an identification of the call center computer in response to sending the identification of the customer computer to the call center system; and
establishing a video and audio Internet Protocol communication channel between the customer computer and the call center computer based on the identification of the customer computer and the identification of the call center computer.

49. The computer-readable medium as recited in claim 47, wherein the instructions further cause the processor to perform the following:
receiving an identification of the customer computer; and
determining customer historical information based on the identification of the customer computer.
